(19) United States
(12) Patent Application Publication
(10) Pub. No.: US 2014/0072363 A1
(43) Pub. Date: Mar. 13, 2014

(54) APPARATUS FOR CONNECTING ELONGATED ELEMENTS

(71) Applicant: Calvin B. BOZE, Bragg Creek (CA)

(72) Inventor: Calvin B. BOZE, Bragg Creek (CA)

(21) Appl. No.: 13/613,029

(22) Filed: Sep. 13, 2012

(51) Int. Cl. F16D 1/00

(52) U.S. Cl. 403/171

(57) ABSTRACT

An apparatus for connecting at least one elongated element is provided. The apparatus include a spherical connection member. The apparatus further includes a plurality of connection mechanisms disposed on the spherical connection member and configured to connect to the at least one elongated element.

### FIELD

The present specification relates generally to connectors and more specifically relates to spherical connectors for elongated elements.

### BACKGROUND

It is often impractical to make structures from a single unitary body. Therefore, rods, tubes, beams, shafts and other elongated elements have often been used as connected parts in the construction of various structures. The parts provide for simple assembly of structures and can be widely applied, for example, as a storage shelf, an exhibit cabinet, a table, a chair, etc. In fact the structures may be assembled in any proper shape to comply with the specific requirements of a desired application. One approach used to connect the parts during construction can involve using adhesives with the required strength. Other approaches include using permanent fasteners such as nails, staples or rivets.

### SUMMARY

In accordance with an aspect of the invention, there is provided an apparatus for connecting at least one elongated element. The apparatus includes a spherical connection member having a first axis, a second axis, and a third axis. Each of the first, second and third axes intersect each other at the center of the spherical connection member and each of the first, second and third axes being perpendicular to each other. The apparatus further includes a plurality of connection mechanisms disposed on the spherical connection member. The plurality of connection mechanisms are configured to connect to the at least one elongated element extending from the spherical connection member along one of the first, second and third axes.

The apparatus may further include another plurality of connection mechanisms disposed on the spherical connection member and may be configured to connect to the at least one elongated element extending from a point on a surface of the spherical connection member located equidistance from each of the first, second and third axes.

The connection mechanism may include a hole configured to receive the elongated element.

A diameter of the hole may be slightly less than a diameter of the elongated element to provide a friction fit.

The apparatus may further include a thread within the hole configured to mate with a corresponding thread on the elongated element.

### BRIEF DESCRIPTION OF THE DRAWINGS

Reference will now be made, by way of example only, to the accompanying drawings in which:

FIG. 1 is a perspective view of an apparatus for connecting a plurality of elongated elements according to an embodiment;

FIG. 2 is another perspective view of the apparatus for connecting a plurality of elongated elements according to the embodiment of FIG. 1;

FIG. 3 is a perspective view of a structure formed using a plurality of the apparatus of FIG. 1;

FIG. 4 is a cross section view of the apparatus for connecting a plurality of elongated elements according to the embodiment of FIG. 1;

FIG. 5 is a cross section view of an apparatus for connecting a plurality of elongated elements according to another embodiment;

FIG. 6 is a perspective view of an apparatus for connecting a plurality of elongated elements according to yet another embodiment;

FIG. 7 is a perspective view of a structure formed using a plurality of the apparatus of FIG. 6;

FIG. 8 is a perspective view of another structure formed using a plurality of the apparatus of FIG. 6.

### DETAILED DESCRIPTION OF THE EMBODIMENTS

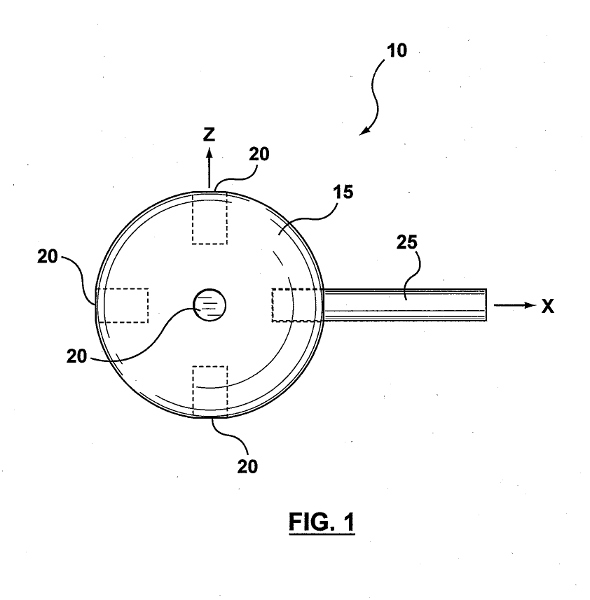

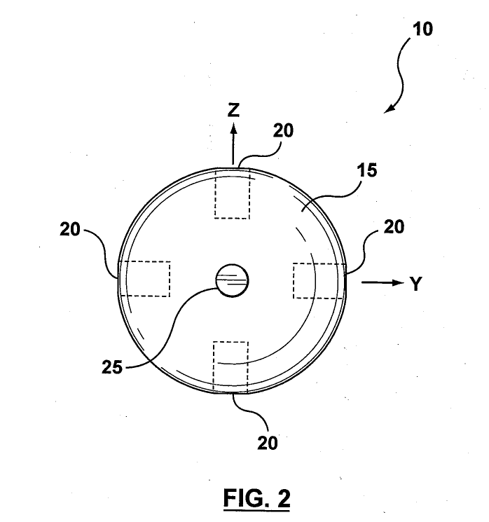

Referring to FIGS. 1 and 2, an apparatus for connecting a plurality of elongated elements is indicated generally at 10. It is to be understood that the apparatus 10 shown is purely exemplary and a variety of different apparatus for connecting a plurality of elongated elements are contemplated. The apparatus 10 includes a connection member 15 and a plurality of connection mechanisms 20.

In the present embodiment, the connection member 15 is generally configured to connect to elongated elements 25 by means of respective connecting mechanisms 20. In the present embodiment, the elongated element 25 is a rod. In other embodiments, the elongated element 25 is not particularly limited and can be modified, for example, to be a hollow tube. It is to be understood that the connection member 15 is also not particularly limited to any material and that several different types of materials are contemplated. The connection member 15 is typically constructed from materials with physical properties appropriate for its intended application. For example, if the connection member 15 is intended to provide structural support, then physical properties of the connection member 15 must be strong and rigid enough to provide the required support. Alternatively, the connection member may be elastic and soft if the intended application is to construct a structure capable of changing shape. Some examples of suitable materials include plastics, wood, composites, some metals and other materials commonly used to provide structural support. In the present embodiment, the connection member 15 is spherical. It is to be appreciated that the spherical shape of the connection member 15 allows for easy manufacture of the connection member 15. For example, spheres can be more easily produced than polyhedron shapes using tools such as a lathe. In other embodiments, the connection member 15 can be modified to be another shape, such as ovoid.

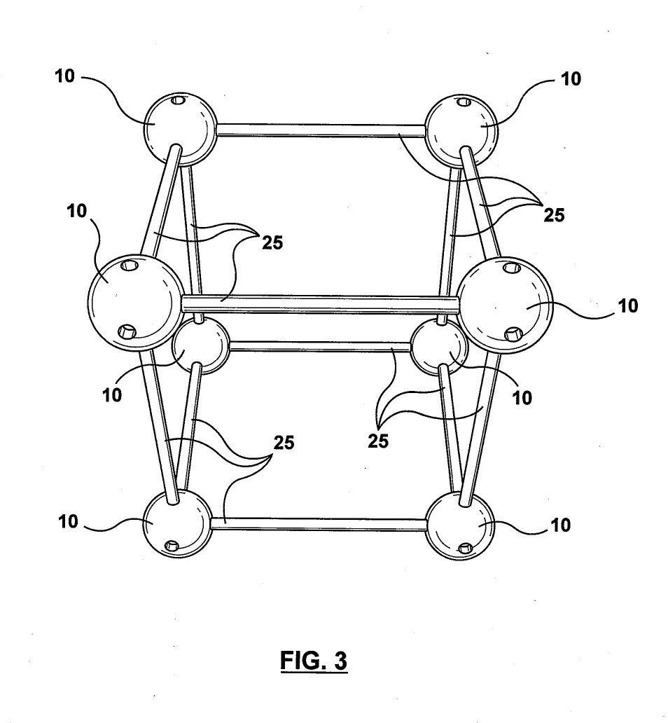

Referring to FIGS. 1 and 2, each connection mechanism 20 is disposed on the surface of the connection member 15. The connection mechanisms 20 are each generally configured to connect to an elongated element 25. In the present embodiment, the plurality of connection mechanisms consists of only connection members disposed on the surface at the intersection of the X, Y, and Z axes, a coordinate system centered at the center of the connection member 15, as shown in FIGS. 1 and 2. The X, Y, and Z axes all intersect at the center of the connection member 15. Furthermore, the X, Y, and Z axes are each perpendicular to each other. Therefore, when the elongated element 25 is connected to one of the connection mechanisms 20, the elongated element 25 extends away from the connection member 15 along one of the X, Y, or Z axes. It is to be appreciated that the present embodiment provides the apparatus 10 with the ability to form many structures with rods perpendicular to each other when the apparatus 10 is combined with other identical apparatus such as shown in FIG. 3 to form a cube.

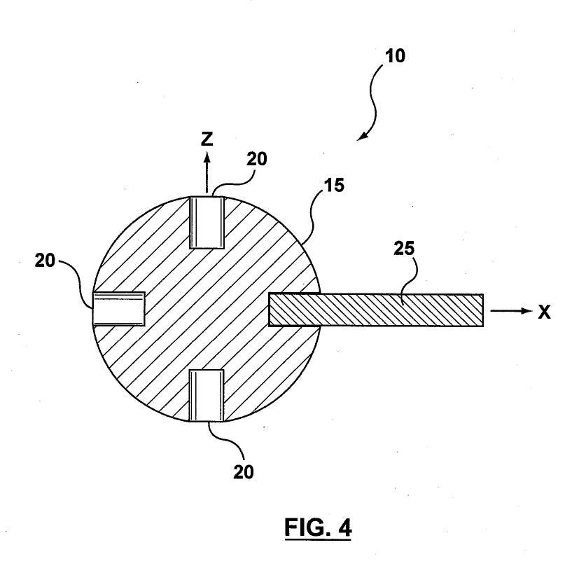

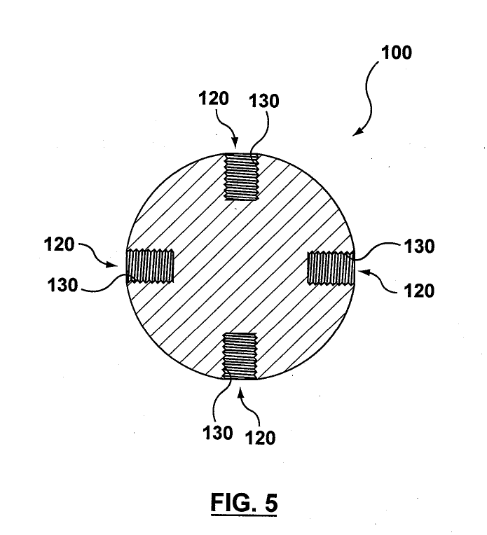

Referring to FIG. 4, the connection members 20 are holes in the present embodiment. Each hole is generally configured to receive an elongated element 25. The manner in which the connection member 20 connects to the elongated element 25 is not particularly limited. In the present embodiment, the diameter of the connection mechanism is slightly less than a diameter of the elongated element 25 to provide a friction fit. In other embodiments, other means to connect the elongated element may be used, such as magnets, adhesives, and clips. For example, in an alternative embodiment shown in FIG. 5, an apparatus 100 includes a thread 130 within the connection mechanism 120 configured to mate with a corresponding thread on the elongated element (not shown).

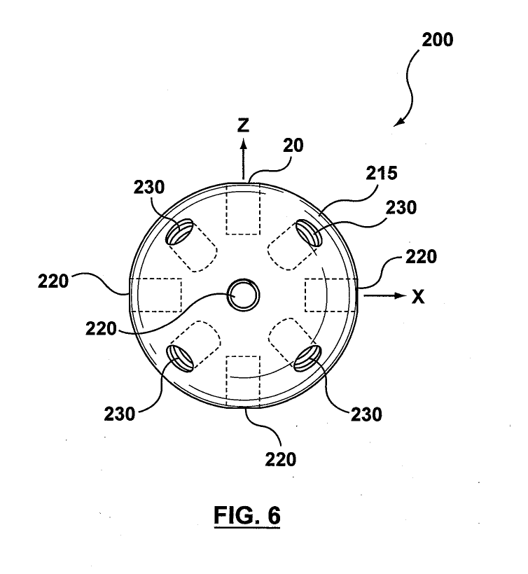

Referring to FIG. 6, an apparatus according to another embodiment for connecting a first plurality of elongated elements is indicated generally at 200. It is to be understood that the apparatus 200 shown is also purely exemplary and it will be apparent to those skilled in the art that a variety of different apparatus for connecting a first plurality of elongated elements are contemplated such as the embodiment discussed above. The apparatus 200 includes a connection member 215, a first plurality of connection mechanisms 220, and a second plurality of connection mechanisms 230.

In the present embodiment, the connection member 215 is generally configured to connect to elongated elements (not shown, but can be similar to the elongated element 25) by means of respective connecting mechanisms 220. It is to be understood that the connection member 115 is not particularly limited to any material and that several different types of materials are contemplated such as those contemplated to be used for the connection member 15. In the present embodiment, the connection member 215 is spherical. It is to be appreciated that the spherical shape of the connection member 215 allows for easy manufacture of the connection member 215. For example, spheres can be more easily produced than polyhedron shapes using tools such as a lathe. In other embodiments, the connection member 215 can be another shape, such as ovoid.

Referring to FIG. 6, each connection mechanism of the first plurality of connection mechanisms 220 is disposed on the surface of the connection member 215. The first plurality of connection mechanisms 220 is similar to the plurality of connection mechanisms 20 in the previously discussed embodiment in that each connection mechanism is generally configured to connect to an elongated element. When an elongated element is connected to one of the connection mechanisms 220, the elongated element extends away from the connection member 215 along one of the X, Y, or Z axes.

Each connection mechanism of the second plurality of connection mechanisms 230 is disposed on the surface of the connection member 215. The second plurality of connection mechanisms are spaced differently from the first plurality of connection mechanisms 220 to give the apparatus 200 greater versatility by allowing the connection of elongated elements at other convenient angles. When the elongated element is connected to one of the connection mechanisms 230, the elongated element extends away from the connection member 115 from a point on a surface of the connection member 215.

In the present embodiment, the apparatus 200 includes fourteen connection mechanisms 220 and 230. By fixing a coordinate system to the connection member 215, the positions of the each connection mechanism 220 or 230 can be described with a polar angle (θ) and an azimuth angle (φ). Based on the Cartesian coordinate system having perpendicular X, Y, and Z axes, the polar angle (θ) describes the angle from the z-axis and ranges from zero degrees (along the positive z-axis) to 180 degrees (along the negative z-axis). The azimuth angle (φ) describes the angle of a point projected onto the x-y plane where the x-axis is at zero degrees and the angle increases in a direction of rotation from the positive x-axis to toward the positive y-axis. The positions of the fourteen holes are summarized in the Table 1.

TABLE 1
Positions of connection members

| Hole | Polar Angle (θ) | Azimuth angle (φ) |
|---|---|---|
| 1 | 0 | N/A |
| 2 | 30 | 45 |
| 3 | 30 | 135 |
| 4 | 30 | 225 |
| 5 | 30 | 315 |
| 6 | 90 | 0 |
| 7 | 90 | 90 |
| 8 | 90 | 180 |
| 9 | 90 | 270 |
| 10 | 150 | 45 |
| 11 | 150 | 135 |
| 12 | 150 | 225 |
| 13 | 150 | 315 |
| 14 | 180 | N/A |

It is to be emphasized that the structure described in Table 1 is a non-limiting representation only. For example, only fourteen connection mechanisms 220 and 230 are described, it is to be understood that the connection member 215 can be modified to include more or less connection mechanisms. Furthermore, it is also to be understood that the exact positions of each connection mechanism is not particularly limited and may be modified to accommodate different applications. Indeed, a plurality of different configurations of connection members are contemplated herein.

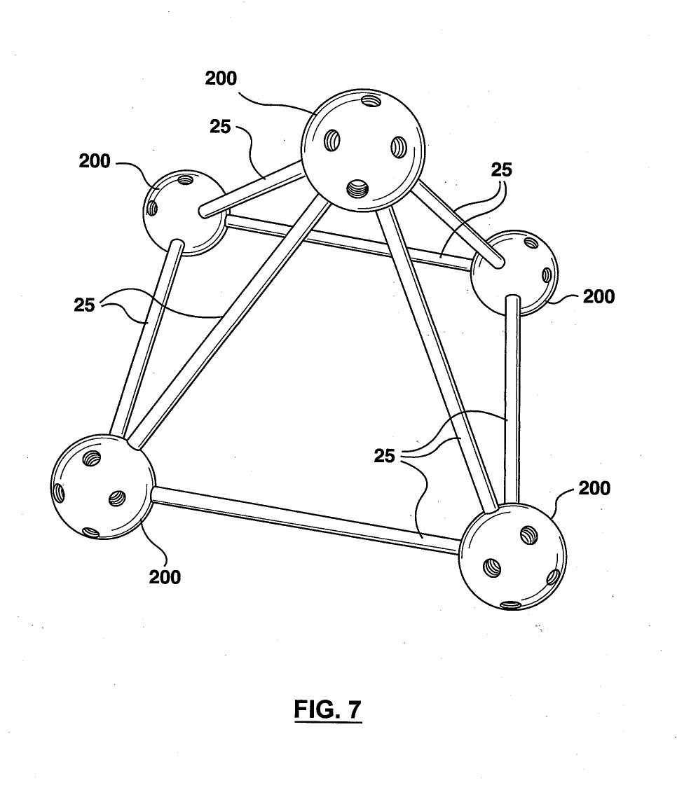

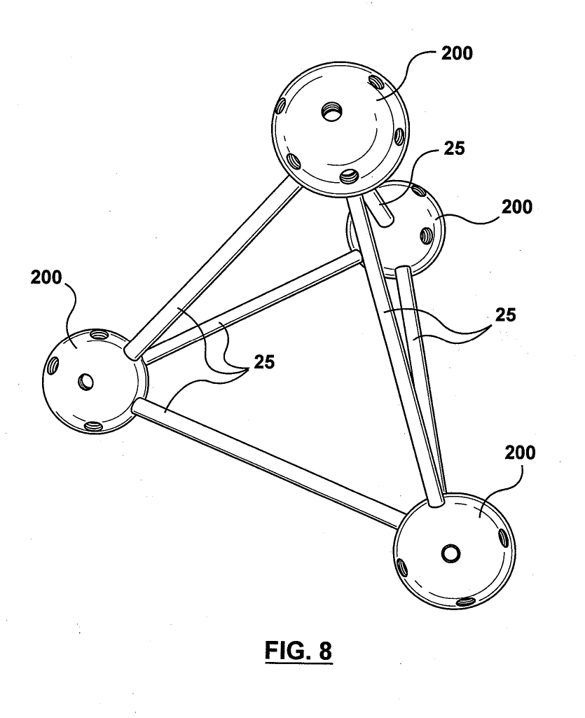

It is to be appreciated that the present embodiment provides the apparatus 200 with the ability to form many structures with elongated elements when the apparatus 100 is combined with other apparatus 100 or even apparatus 10. For example, the apparatus 200 can form shapes such as a pyramid shown in FIG. 7. As another example, apparatus 200 can also be used to form a tetrahedron as shown in FIG. 8.

It is to be understood that many combinations, variations and subsets of the embodiments and teachings herein are contemplated. As a non-limiting example, the apparatus 10 can be modified with the variation described in relation to the apparatus 100 such that only some of the connection members are threaded. As a non-limiting example, the apparatus 200 can be modified with the variation described in relation to the apparatus 100 such that the connection members are threaded.

Various advantages will now be apparent. Of note is ease with which an apparatus can be manufactured using standard machining tools such as a simple lathe. Furthermore, it will be appreciated that the uniformity and the fact that the connection mechanisms are ideally spaced at convenient angles will provide for easy construction of several structures using a plurality of the apparatus.

While specific embodiments have been described and illustrated, such embodiments should be considered illustrative only and should not serve to limit the accompanying claims.

What is claimed is:

1. An apparatus for connecting at least one elongated element, comprising:
a spherical connection member having a first axis, a second axis, and a third axis, each of the first, second and third axes intersecting each other at the center of the spherical connection member and each of the first, second and third axes being perpendicular to each other; and
a plurality of connection mechanisms disposed on the spherical connection member and configured to connect to the at least one elongated element extending from the spherical connection member along one of the first, second and third axes.

2. The apparatus of claim 1, comprising a further plurality of connection mechanisms disposed on the spherical connection member and configured to connect to the at least one elongated element extending from a point on a surface of the spherical connection member located equidistance from each of the first, second and third axes.

3. The apparatus of claim 1, wherein the connection mechanism comprises a hole configured to receive the elongated element.

4. The apparatus of claim 3, wherein a diameter of the hole is slightly less than a diameter of the elongated element to provide a friction fit.

5. The apparatus of claim 3, further comprising a thread within the hole configured to mate with a corresponding thread on the elongated element.
